(19) United States
(12) Patent Application Publication
(10) Pub. No.: US 2002/0172346 A1
(43) Pub. Date: Nov. 21, 2002

(54) Extension-dependent call forwarding in an exchange

(76) Inventors: Michael Geissler, Stockerau (AT); Richard Poschl, Sooss (AT)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/151,293

(22) Filed: May 21, 2002

(30) Foreign Application Priority Data
May 21, 2001 (DE) 10124764.8

(51) Int. Cl. H04M 3/42; H04M 7/00

(52) U.S. Cl. 379/220.01; 379/211.02

(57) ABSTRACT

For performing call forwarding from terminal stations of a dependent switch which is configured as second switch connected at the exchange (e.g. from extensions of a private branch exchange PBX), an exchange sets up a call forwarding list in which a call address is in each case allocated to a terminal station code as forwarding destination for one or more terminal stations of the dependent switch. When a connection request relating to a subscriber at a dependent switch of the exchange arrives, the code of the desired terminal station is used for checking whether a call address is allocated to this code in an associated call forwarding list. If this is so, the connection is forwarded to this call address.

### CLAIM FOR PRIORITY

This application claims priority to Application No. 10124764.8 which was filed in the German language on May 21, 2001.

### TECHNICAL FIELD OF THE INVENTION

The invention relates to a method for establishing a connection through an exchange of a telecommunication network, and in particular, for establishing a connection for a subscriber to whom (at least) one terminal station of a dependent switch is allocated, and relates to an exchange for a telecommunication network to which at least one switch can be configured and/or connected as a dependent switch.

### BACKGROUND OF THE INVENTION

For purposes of discussion, the dependent switch is a private branch exchange. Private branch exchanges (PBX) are used for implementing a private local area network, e.g. a business network, having its own switching facilities. On the one hand, a private branch exchange is connected to an exchange of the higher-level—in most cases, public—network via one or more connections which, as a rule, are line-connected. On the other hand, the subscribers of a private branch network are typically allocated extensions and the private branch exchange is used for establishing and controlling telecommunication connections between the extensions via local connections and connections of the extensions to external subscribers. In the case of network connections to external subscribers, the extensions usually jointly use the connections of the private branch exchange as higher-level network which are allocated one or more directory numbers of the higher-level network. The individual extensions can be addressed by their own identifications which include, e.g., of one or more selection digits and, in particular, can be used within the private branch network in the manner of a directory number. From outside the private branch network, they are usually used in combination with a group number, as a rule or suffix appended to the group number.

A well-known feature of private branch exchanges is the forwarding of calls from one extension to another extension. Often, however, further call forwarding—also called “external call forwarding” in the text which follows—is desired in which the calls are to be conducted from an extension of a private branch exchange to a forwarding address which is located outside the private branch network, e.g. to a connection of the higher-level network.

In a conventional solution for external call forwarding, the connection is set up to the private branch exchange where the presence of a call forwarding is detected by means of the extension code and the connection to the directory number is conducted back to the exchange in accordance with the programmed call forwarding. As a result, two telecommunication channels (e.g. two voice channels) between the exchange and the private branch exchange are occupied for the duration of the call.

In order to avoid occupying channels between the exchange and the private branch exchange in the case of an external call forwarding set up in the private branch exchange, the possibility of so-called “partial rerouting” is provided for ISDN private branch exchanges, compare in this context ETSI standard EN 300 207-1, chapter 10. According to this “partial rerouting”, the exchange occupies a connection channel to the private branch exchange for a short time during the setting up of the connection to the forwarding address. However, the solution according to the the ETSI standard assumes certain capabilities of the private branch exchange, particularly detailed signaling of information regarding the call forwarding.

In addition, it is not possible with the solutions to set up exchange-specific call forwarding to the new terminal stations in each case allocated to the subscribers in the case of the clearing down of a private branch network. Instead, call forwarding can only be set up with respect to the group number which thus relates to the entire (former) private branch network as a whole.

### SUMMARY OF THE INVENTION

The invention discloses performing call forwarding in an upstream exchange, preferably for external call forwarding to private branch exchanges, in which occupying the dependent switch or private branch exchange is avoided. In addition, special requirements for the signaling of the dependent switch or private branch exchange should be dispensed with.

In one embodiment of the invention, the exchange, by using at least one call forwarding list in which at least one call address which differs from the call address of the relevant terminal station is allocated in each case one code of the terminal station for at least one terminal station of a dependent switch, when a connection request relating to a subscriber at a dependent switch configured in the exchange arrives,

a) takes a code relating to a desired terminal station of the dependent switch from this connection request,

b) using this code, checks whether a call address is allocated to the relevant code in a call forwarding list allocated to the dependent switch, and if this is so,

c) forwards the connection to this call address (i.e. the one found in (b)).

In one aspect of the invention, the control device can set up at least one call forwarding list for dependent switches configured at the exchange, in which at least one call address which differs from the call address of the relevant terminal station is allocated to in each case one code of the terminal station for at least one terminal station of a dependent switch, and furthermore, the control device is set up for taking, when a connection request relating to a subscriber at a dependent switch configured at the exchange arrives, a code relating to a desired terminal station of the dependent switch from this connection request, checking, by using this code, whether a call address is allocated to the relevant code in a call forwarding list allocated to the dependent switch, and if this is so, forwarding the connection to this call address.

Another embodiment of the invention relates to the implementation with respect to a private branch network. In this embodiment, the dependent switch exists in the form of a private branch exchange and the connection request relates to an extension of the private branch exchange. When the connection request arrives,

a) a code relating to a desired extension of the private branch exchange is taken from this connection request, in addition to the call address of the relevant private branch exchange,

b) using this code, a check is made as to whether a call address is allocated to the relevant code in a call forwarding list allocated to the private branch exchange, and if this is so,

c) the connection is forwarded to this call address.

It is advantageous if, when the connection request arrives, a check is made even before (a) as to whether call forwarding list allocated to the relevant dependent switch is set up for this switch and the further method, starting from (a), is executed if this is so.

The invention allows implementation of extension-related call forwarding, on execution of which no signaling with the relevant dependent switch and no occupying of connection channels is required since the processing of the diversion takes place completely in the high-level exchange if, naturally, external call forwarding is active and the call forwarding is not directed to a terminal station of the network region assigned to the dependent switch.

A particular advantage of the invention is that the call forwarding can be executed by the exchange even if the relevant dependent switch, particularly private branch exchange, is not connected or even exists at all. Instead, it is sufficient for the invention if the private branch exchange is configured at the exchange, regardless of the actual presence of the private branch exchange.

### BRIEF DESCRIPTION OF THE DRAWINGS

In the text which follows, the invention and further advantages will be explained in greater detail with reference to an exemplary embodiment, using the attached drawings, in which:

FIG. 1 shows an exemplary private branch network and an associated exchange.

FIG. 2 shows a call forwarding list allocated to a private branch exchange.

FIG. 3 shows a flowchart of processing of a forwarded call.

### DETAILED DESCRIPTION OF THE PREFERRED EMBODIMENTS

The exemplary embodiment relates to a private branch exchange which is connected to an exchange of a public network. It should be noted at this point that the exemplary embodiment is not restrictive. In particular, the invention can be generally used for implementing external call forwarding between a switching system and a second switch which is allocated to it as a dependent switch, the dependent switch being of the same level as or of a lower level than the first switching system. In general, the invention can be applied to switching systems of any type, including switching systems of public and private networks. In addition, the two switching systems do not necessarily have to be connected to one another directly but can also be connected indirectly—e.g. via other switching facilities.

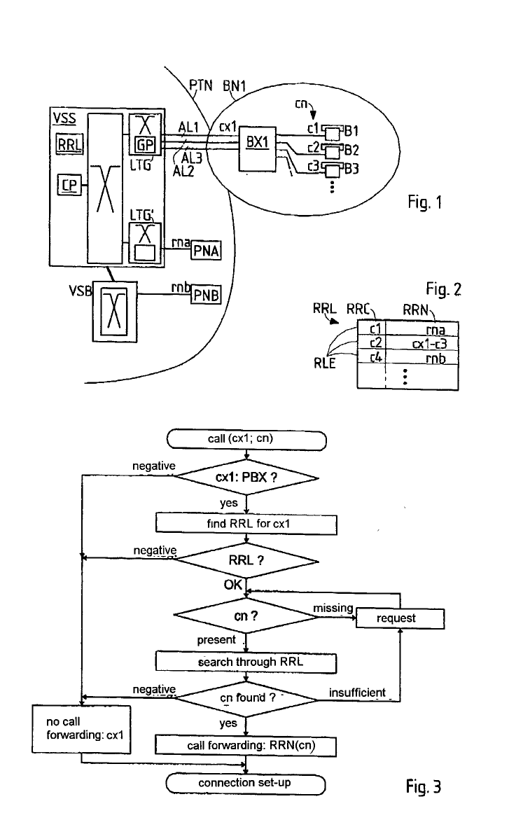

Referring to FIG. 1, a private branch exchange BX1 is connected to an exchange VSS of a telecommunication network, a public telephone network PTN in the example considered here, via three access lines AL1, AL2, AL3. The private branch exchange BX1 serves a private branch network BN1 to which a number of extension users Bn=B1, B2, B3, . . . belongs. The exchange VSS is, e.g. an EWSD system by the applicant, in which the connections are connected to a central switching network SN via line trunk groups LTG. In addition to the central control processor CP of the exchange VSS, so-called group processors GP which take the load of line trunk group-specific switching tasks of the switching operation off the central processor CP are also provided in the line trunk groups LTG. A group number cx1 is allocated to the private branch exchange BX1 or, respectively, the private branch network BN1 in the telephone network PTN. In the private branch network, a direct dialing number cn=c1, c2, c3, . . . , for example in each case a two-digit number c1=“22”, c2 =“23”, etc., is in each case allocated to each extension Bn.

To implement the extension-specific call forwarding according to the invention, screening for the direct dialing number cn dialed after the group number is performed in the exchange VSS in the case when a connection request for the directory number cx1 arrives at the private branch exchange BX1. The invention thus provides that the extension code is not passed transparently to the private branch exchange BX1 as in previously used methods but is used by the exchange VSS for influencing the switching sequence. For this purpose, a call forwarding list RRL allocated to the private branch exchange BX1 is provided in the database of the exchange VSS. This list includes e.g. a number of entries RLE which, e.g., in each case include two components. The first component RRC specifies an extension code for which a call forwarding according to the invention is to be performed. The second component RRN specifies, in each case, the associated forwarding destination.

For example, as shown in FIGS. 1 and 2, the extension B1, which can be reached via the number c1, is forwarded to the subscriber PNA having the directory number rna and similarly the extension having the code c4 is forwarded to the subscriber rnb corresponding to the directory number rnb, which, for example, is connected to another exchange VSB. Naturally, the call addresses mentioned as forwarding destinations are not restricted to subscribers who are connected to the exchange VSS but can be any subscribers belonging to the network PTN or available via this network. In addition, the forwarding destination mentioned can be an extension of another private branch exchange or of the same one as shown in the example of extension B2—code c2—which is forwarded to code c3, or respectively, extension B3.

The call forwarding according to the invention is administered by the network PTN, e.g. by the network operator, to the exchange VSS and relates to the administration (setting up, processing, etc.) of the list RRL. In addition, service-dependent administration of the call forwarding for the private branch exchange BX1 is also possible in order to activate the call forwarding in a service-dependent manner—e.g. only for fax calls—for example, in the case of ISDN subscribers or an ISDN private branch exchange. For this purpose, an additional feature can be introduced in the call list RRL or the entries RLE which specifies the service for which the call forwarding is to be performed.

It is also conceivable that the call forwarding according to the invention can be controlled from the private branch exchange BX1 or an extension B1, . . . at the exchange VSS. This can be done e.g. in accordance with the principles of subscriber controlled input (SCI), in which the call forwarding for an extension is input from this extension, or of remote subscriber controlled input (RSCI) in which the call forwarding is input from another extension—for example protected by password—compare in this context ETSI standard EN 300 207-1, chapter 9, and ETSI standard EN 300 691. Naturally, the SCI-oriented method requires that the extension for which the call forwarding is set up actually exists whereas this is not mandatory in the case of an RSCI method.

FIG. 3 shows an example of a switching sequence of a call forwarding according to the invention which takes place at the exchange VSS. The call forwarding is performed by the central processor CP with the aid of the group processor GP.

When a connection request for a line cx1 of the exchange arrives—it is possible that a code (e.g. direct dialing digits) of an extension is already supplied together with the call address cx1 at this point—a check is first made as to whether the call address cx1 specified in the connection request relates to a private branch exchange and whether extension-oriented call forwarding according to the invention is activated for this. If yes, a further check is made as to whether an associated call forwarding list RRL exists for the call address cx1. If this is not so (“negative” branches), the connection to the call address cx1 is set up in a familiar manner without call forwarding.

In the case of relevance here (“OK” branch), that the connection request relates to a private branch exchange—namely the private branch exchange BX1 connected to the connection cx1, for which call forwarding and a call forwarding list RLL according to the invention are set up, a check is made for an extension code. For the example considered here, in which the code is implemented as suffix of the group number cx1 (so-called “direct dialing”) in the form of selection digits, a check is made as to whether direct dialing digits have been dialed. If this is not so (“missing”), the direct dialing digits (or generally a code) are requested. If a code cn exists (“present”), the call forwarding list RLL is searched for cn in the column RRC. The search supplies one of the following three results:

1) The code cn is found in the list RRL. The connection is forwarded to the call address RRL (cn) mentioned in the RRL component.

2) The code cn is not found. The further connection setup is then carried out without call forwarding (“negative” branch), the code cn is forwarded to the private branch exchange as in the known method of the connection setup.

3) No unambiguous statement is possible—usually because additional direct dialing digits are necessary or the given extension code cn is not adequate for unambiguous selection of an entry for other reasons. In this case (“inadequate” branch) completion of the code—e.g. further direct dialing digits—is requested.

The invention can be used with respect to analog and digital (like ISDN) private branch exchanges, preferably private branch exchanges with direct dialing. One aspect of the invention is that for it to be possible for the call forwarding according to the invention to be performed, it is sufficient if the private branch exchange is configured at the exchange regardless of the actual presence of the private branch exchange. For this reason, the invention can perform extension-specific call forwarding even if the relevant private branch exchange or the associated private branch network has been partially, or wholly removed (e.g. relocated).

Furthermore, the call-forwarding according to the invention can also be cascaded in such a manner that the forwarding destination itself is a second exchange or private branch exchange for which an extension-specific call forwarding is set up.

What is claimed is:

1. A method for establishing a connection through an exchange of a telecommunication network, for a subscriber allocated a terminal station of a dependent switch, comprising:
allocating one code of a terminal station for at least one of a plurality of terminal stations of a dependent switch using at least one call forwarding list in which at least one call address differs from a relevant terminal station, when a connection request relating to the subscriber at the dependent switch configured in the exchange arrives;
taking a code relating to a desired terminal station of the dependent switch from the connection request;
checking, using this code, whether a call address is allocated to the relevant code in a call forwarding list allocated to the dependent switch; and
forwarding the connection to the call address if the call address is allocated.

2. The method as claimed in claim 1, further comprising configuring a private branch exchange as the dependent switch and the connection request relates to an extension of the private branch exchange, and
when the connection request arrives, taking a code relating to a desired extension of the private branch exchange from the connection request, using the code,
checking whether a call address is allocated to the relevant code in a call forwarding list allocated to the private branch exchange, and
if the call address is allocated, forwarding the connection to the call address.

3. The method as claimed in claim 1, wherein when the connection request arrives, a check is made as to whether a call forwarding list allocated to the relevant dependent switch is set up for the switch and if the call forwarding list has been allocated, performing the taking and checking.

4. An exchange for a telecommunication network to which at least one switch is configured and/or connected as a dependent switch, comprising:
a control device to control the setting-up, maintenance and clearing-down of telecommunication connections from and to subscribers allocated to the exchange, wherein the control device sets up at least one call forwarding list for dependent switches configured at the exchange, in which at least one call address which differs from the call address of a relevant terminal station is allocated to one code of the terminal station for at least one terminal station of a dependent switch, and
the control device is set up for taking, when a connection request relating to a subscriber at a dependent switch configured at the exchange arrives, a code relating to a desired terminal station of the dependent switch from the connection request, and the control device checks, using the code, whether a call address is allocated to the relevant code in a call forwarding list allocated to the dependent switch, and the control forwards the connection to the call address if the call address is allocated.

5. The method as claimed in claim 2, wherein when the connection request arrives, a check is made as to whether a call forwarding list allocated to the relevant dependent switch is set up for the switch and if the call forwarding list has been allocated, performing the taking and checking.
